(19) United States
(12) Patent Application Publication
(10) Pub. No.: US 2025/0328295 A1
(43) Pub. Date: Oct. 23, 2025

(54) JOB PROCESSING DEVICE, IMAGE PROCESSING APPARATUS, AND JOB PROCESSING METHOD

(71) Applicant: Sharp Kabushiki Kaisha, Osaka (JP)

(72) Inventor: DAIKI YASHIMA, Osaka (JP)

(21) Appl. No.: 19/096,906

(22) Filed: Apr. 1, 2025

(30) Foreign Application Priority Data
Apr. 19, 2024 (JP) 2024-068286

(51) Int. Cl. G06F 3/12; G06F 21/31

(52) U.S. Cl. CPC G06F 3/1238; G06F 3/1222; G06F 3/1259; G06F 3/1285; G06F 21/31

(57) ABSTRACT

A job processing device includes an authenticator that authenticates login of a user, an executor that executes a job on the basis of an execution instruction from the user authenticated, and one or more controllers that control output of a deliverable resulting from execution of the job to a portable storage medium. The one or more controllers, when the deliverable is acquired via the portable storage medium and a logged-in user is the same as the user providing the execution instruction of the job, notify the user of a processing status of the job in the executor.

### FIELD OF THE INVENTION

The disclosure relates to a job processing device and the like.

### BACKGROUND ART

In image processing apparatuses such as multifunction peripherals, by using a portable storage medium (hereinafter also simply referred to as external memory) such as universal serial bus (USB) memory, users can execute scan jobs that save deliverables based on image reading as scanned data in the external memory, and execute print jobs that print selected files saved in the external memory.

A user utilizing an image processing apparatus attaches the external memory to the image processing apparatus when executing a scan job or a print job, and detaches the external memory from the image processing apparatus after acquisition of the deliverable or after completion of the print job (after output of printed material).

PTL 1 describes, for example, an image data output method and the like that, when image data is received from an image processing apparatus, are designed to not cause a user to wait at the image processing apparatus and to enhance security of image data transfer.

### CITATION LIST

### Patent Literature

PTL 1: JP 2011-66470 A

### SUMMARY

### Technical Problem

An object of the disclosure is to provide a job processing device and the like related to job processing that utilizes a portable storage medium, the job processing device and the like being highly convenient for a user.

### Solution to Problem

To solve the problems described above, a job processing device according to the disclosure includes an authenticator that authenticates login of a user, an executor that executes a job on the basis of an execution instruction from the user authenticated, and one or more controllers that control output of a deliverable resulting from execution of the job to a portable storage medium. The one or more controllers, when the deliverable is acquired via the portable storage medium and a logged-in user is the same as the user providing the execution instruction of the job, notify the user of a processing status of the job in the executor.

Further, an image processing apparatus according to the disclosure includes an authenticator that authenticates login of a user, an image processor that executes a job related to image processing on the basis of an execution instruction from the user authenticated, and one or more controllers that control output of a deliverable resulting from execution of the job to a portable storage medium. The one or more controllers, when the deliverable is acquired via the portable storage medium and a logged-in user is the same as the user providing the execution instruction of the job, notify the user of a processing status of the job in the executor.

Further, a job processing method according to the disclosure includes authenticating login of a user, executing a job on the basis of an execution instruction from the user authenticated, and controlling output of a deliverable resulting from execution of the job to a portable storage medium. When the deliverable is acquired via the portable storage medium and a logged-in user is the same as the user providing the execution instruction of the job, the user is notified of a processing status of the job.

### Advantageous Effects of Disclosure

According to the disclosure, it is possible to provide a job processing device and the like related to job processing that utilizes a portable storage medium, the job processing device and the like being highly convenient for a user.

### BRIEF DESCRIPTION OF THE DRAWINGS

FIG. 1 is a diagram for explaining an overall configuration of an image processing apparatus according to a first embodiment.

FIGS. 2A and 2B are diagrams for explaining a functional configuration of the image processing apparatus according to the first embodiment.

FIG. 3 is a flowchart for explaining a processing flow according to the first embodiment.

FIG. 4 is a flowchart for explaining a processing flow according to the first embodiment.

FIG. 5 is a flowchart for explaining a processing flow according to the first embodiment.

FIG. 6 is a diagram for explaining an identification information table.

FIG. 7 is a diagram for explaining an operation example according to the first embodiment.

FIG. 8 is a diagram for explaining an operation example according to the first embodiment.

FIG. 9 is a diagram for explaining an operation example according to the first embodiment.

FIG. 10 is a diagram for explaining an operation example according to the first embodiment.

FIG. 11 is a flowchart for explaining a processing flow according to a second embodiment.

FIG. 12 is a flowchart for explaining a processing flow according to the second embodiment.

FIG. 13 is a diagram for explaining a file identification information table.

FIG. 14 is a diagram for explaining an operation example according to the second embodiment.

FIG. 15 is a diagram for explaining a functional configuration of an image processing apparatus according to a third embodiment.

### DETAILED DESCRIPTION OF THE INVENTION

Embodiments according to the disclosure will be described below with reference to the drawings. In the disclosure, embodiments of an image processing apparatus will be described in which a job processing device according to the disclosure is implemented by a multifunction peripheral that can execute jobs involving printing, copying, scanning, faxing, and email, for example, with a single housing. Note that the following embodiments are examples for explaining the disclosure, and the technical content of the explanation described in the claims is not limited to the following description.

A typical process (scan job) of saving scanned data to external memory is executed according to a procedure of:
(1) attaching external memory to the multifunction peripheral,
(2) configuring settings such as resolution and density for image reading, and a file format of the deliverable (settings regarding use of special functions such as optical character recognition (OCR) and file encryption),
(3) reading an image,
(4) executing OCR processing and file encryption processing,
(5) saving the deliverable in the external memory, and
(6) detaching the external memory.

For a scan job, the external memory cannot be detached until the saving of the deliverable in the external memory is completed. Accordingly, the user presumably waits in front of the multifunction peripheral until the scan job is completed. In particular, in a case in which a large-volume document is scanned and the OCR function is enabled or the like, the processing according to (3) and (4) described above requires a long time, and thus the user may be kept waiting in front of the multifunction peripheral for an extended period.

To solve such problems, PTL 1, for example, describes a technique in which external memory is detachable from an image processing apparatus during execution of a scan job, the processing described above, such as (3) reading an image, (4) OCR processing, file encryption processing, and the like, is continuously executed even after detachment of the external memory and, after the processing is completed, the same external memory is attached again, making it possible to resume the processing from the above-described processing of (5) saving the deliverable in the external memory.

However, PTL 1 is problematic in that:
(a) the timing in which the external memory is attached the second time for deliverable acquisition is difficult to determine (users have trouble identifying whether the processing of (4) and (5) described above are completed),
(b) the user may forget to acquire the scanned data as a deliverable,
(c) the user may lose the external memory utilized during scan job execution and thus not be able to acquire the deliverable, and
(d) the external memory needs to be attached to the multifunction peripheral at least twice (once during scan job execution and once during deliverable acquisition).

On the other hand, a process (print job) of printing files saved in external memory is executed according to a procedure of:
(7) attaching external memory to the multifunction peripheral,
(8) selecting the file to be printed,
(9) configuring print settings for the file to be printed, such as original document size, number of copies, color or black and white settings, and double-sided printing,
(10) reading the file to be printed from the external memory,
(11) printing, and
(12) detaching the external memory (note that, typically, the external memory can be detached after the processing of (10) (reading the file to be printed)).

In a print job, the external memory can be detached from the multifunction peripheral after the file to be printed is read from the external memory in (10) described above, and thus the period required for attaching the external memory to the multifunction peripheral is not long as compared with that in the scan job described above. However, when the print job fails due to detachment of the external memory from the multifunction peripheral before completion of the reading of the file to be printed from the external memory in (10) described above and the print job is to be executed again, it is necessary to redo the processing from attachment of the external memory to the multifunction peripheral in (7) described above. In this case, it may be necessary to reselect the file to be printed according to (8) described above and reconfigure the print settings according to (9) described above.

The disclosure provides a solution to the problems described above, and realizes, in the embodiments below, a multifunction peripheral equipped with a job processing device that is related to job processing that utilizes a portable storage medium, the job processing device being highly convenient for a user.

### 1. First Embodiment

In a first embodiment, a form of saving scanned data in external memory (scan job) will be described.

### 1.1 Functional Configuration

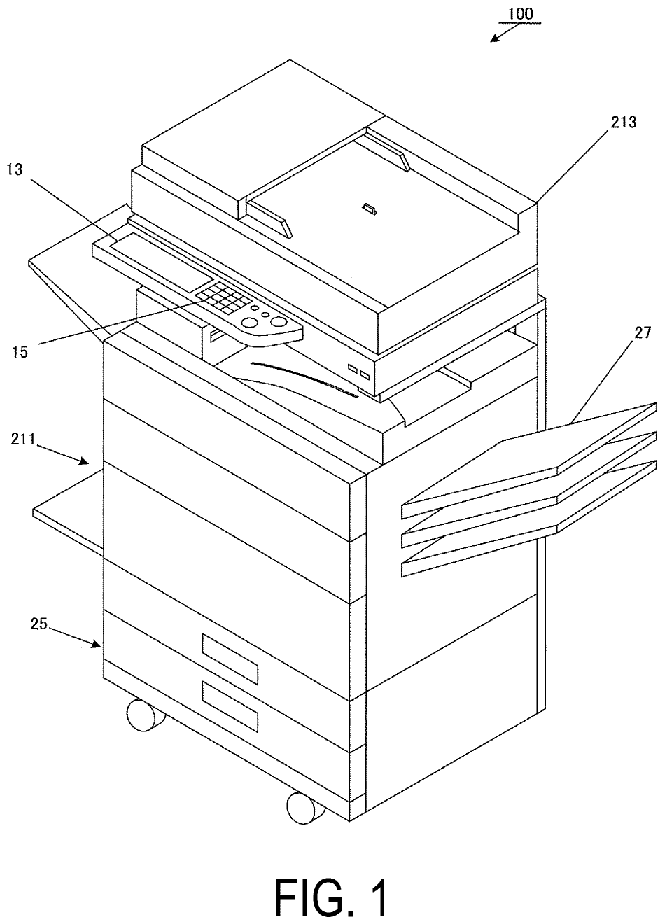

FIG. 1 is a diagram for explaining an overall configuration of an image processing apparatus 100 equipped with a job processing device 105 according to the first embodiment. In the first embodiment, a form of a multifunction peripheral will be described as one example of the image processing apparatus 100, but the image processing apparatus 100 is not particularly limited as long as the device has a configuration equipped with the job processing device 105 according to the first embodiment, and may be, for example, a printer, a copier, or a FAX machine in which various job functions are limited.

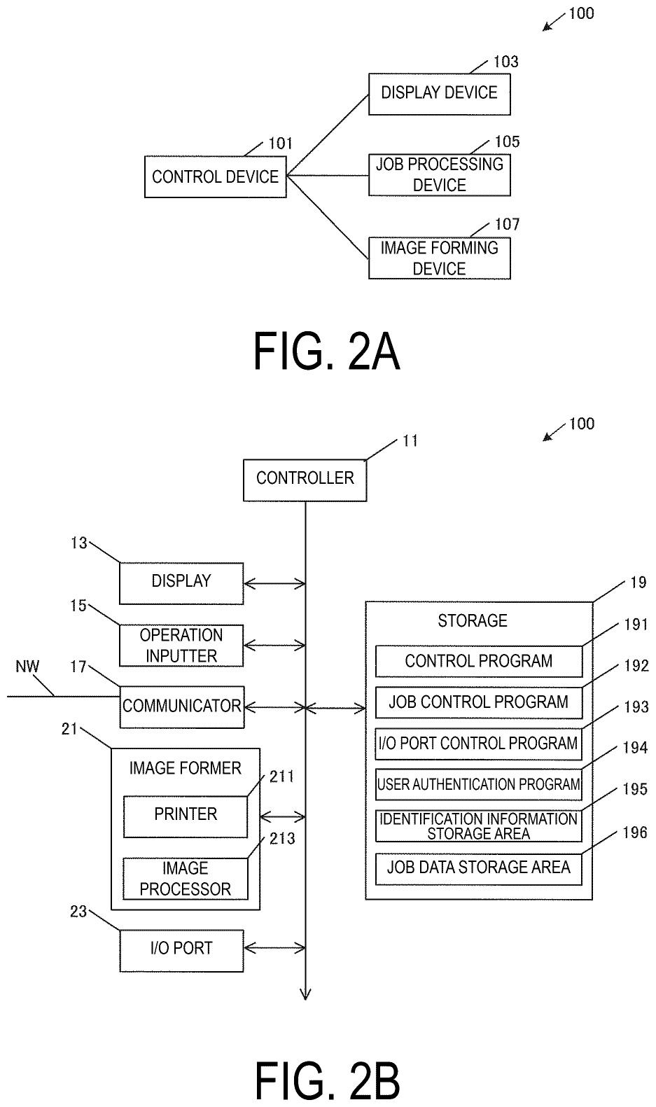

FIG. 2A is a diagram for explaining a device configuration of the image processing apparatus 100. The image processing apparatus 100 includes a control device 101, a display device 103, the job processing device 105, and an image forming device 107. Each of the devices illustrated in FIG. 2A may be integrally formed, or a plurality of the devices may be configured in combination. For example, the display device 103 and the job processing device 105 may be a single device.

FIG. 2B is a diagram for explaining a functional configuration of the image processing apparatus 100. Each function illustrated in FIG. 2B may be performed by each device illustrated in FIG. 2A, respectively, as necessary.

The image processing apparatus 100 includes, as the functional configuration, a controller 11, a display 13, an operation inputter 15, a communicator 17, a storage 19, an image former 21, and an I/O port 23.

The controller 11 fully controls the image processing apparatus 100. The controller 11 can be constituted by, for example, one or more processing devices (central processing units (CPU), systems on a chip (SoC), or the like). The controller 11 implements a function thereof by reading and executing various programs stored in the storage 19.

The display 13 displays various types of information for a user. The display 13 can be constituted by, for example, a liquid crystal display (LCD) or an organic electro-luminescence (EL) display. The display 13 displays an operation screen corresponding to a state of the image processing apparatus 100 (for example, a home screen, a setting screen related to execution of each job, or a history information screen), a notification screen that provides a notification prompting acquisition of a deliverable when processing of a job is completed and provides notification that the processing of a job is not completed when the processing of the job is not yet finished, and the like.

The operation inputter 15 receives input of information by the user or the like. The operation inputter 15 can be constituted by various input devices such as operation keys, such as hardware keys and software keys, and buttons. Note that the operation inputter 15 can also be configured as a touch panel that enables input via the display 13. When configured as a touch panel, the operation inputter 15 can detect a touch, a tap, a swipe operation, or the like of the user on an object displayed via the display 13 and acquire coordinate information, pressure-sensitive information, and the like on the touch panel. The acquired coordinate information, pressure-sensitive information, and the like can be used to determine an operation location and an operation time of the user with respect to the object, or the like. Note that, as an input method for the touch panel, for example, a general method such as a resistance film method, an infrared beam method, an electromagnetic induction method, or an electrostatic capacitance method can be employed.

The communicator 17 includes, for example, one or both of wired and wireless interfaces for performing communication with other external terminal devices (not illustrated) via a network NW such as a local area network (LAN), a wide area network (WAN), the Internet, a telephone line, or a FAX line. Further, the communicator 17 may include, for example, an interface related to (short-range) wireless communication technology such as Bluetooth (trade name), near field communication (NFC), Wi-Fi (trade name), ZigBee (trade name), Infrared Data Association (IrDA), or a wireless universal serial bus (USB).

The storage 19 is constituted by one or more storage devices and stores various programs and various data necessary for the operation of the image processing apparatus 100. The storage 19 may be constituted by, for example, a storage device such as a random access memory (RAM), a solid state drive (SSD), a hard disk drive (HDD), or a read only memory (ROM).

In the first embodiment, the storage 19 stores a control program 191, a job control program 192, an I/O port control program 193, and a user authentication program 194, and secures an identification information storage area 195 and a job data storage area 196.

The control program 191 is a program read by the controller 11 when performing centralized control of the job processing device 105 and the image processing apparatus 100. The controller 11, after reading the control program 191, controls driving of hardware such as the display 13, the operation inputter 15, the communicator 17, the image former 21, and the I/O port 23.

The job control program 192 is a program read by the controller 11 when executing a print job related to printing, copying, or the like, a scan job for saving, in external memory or a specific storage device (regardless of whether inside or outside the image processing apparatus 100), scanned data as a deliverable generated by reading an image, or a transmission job related to FAX transmission, email transmission, or the like. The controller 11, having read the job control program 192, functions as an executor, transitions a device mode to a job mode (print mode or scan mode, for example) for executing each job, and then executes the corresponding jobs. The controller 11, having transitioned to each job mode, can display an operation screen for receiving selection of a setting value or a function necessary for execution of a job from the user, as necessary. The controller 11 executes each job on the basis of a setting value, a function, or the like received via the operation screen.

The I/O port control program 193 is a program read by the controller 11 when detecting whether a USB memory is attached or detached as external memory through the I/O port 23. The I/O port control program 193 is compatible with a communication standard such as USB 1.1, USB 2.0, USB 5 Gbps, USB 10 Gbps, USB 20 Gbps, or USB 40 Gbps, for example, and controls input/output of information to/from the attached USB memory when attachment/detachment of the USB memory to/from the I/O port 23 is detected.

The user authentication program 194 is a program read by the controller 11 when a user attempting to log in to the image processing apparatus 100 is authenticated. The controller 11, having read the user authentication program 194, operates as an authenticator that operates on the basis of a user authentication function and, when the user authentication function is enabled, causes a login screen described below to be displayed on the operation inputter 15 (display 13), and then receives input of authentication information related to the user authentication. For example, in a case in which the authentication condition is a combination of a login username and a login password, the controller 11 can perform user authentication by storing login usernames and login passwords related to the user authentication in association with each other in advance and comparing the login username and the login password input via the login screen with the stored login usernames and login passwords. Note that the user authentication may be, for example, possession-based authentication using a token, a key, an integrated circuit (IC) card, or a smartphone, or biometric authentication such as face authentication or fingerprint authentication, in addition to knowledge-based authentication combining a login username and a login password.

The identification information storage area 195 is a storage area that stores identification information such as identification information for identifying a user who utilizes the image processing apparatus 100 (user ID: username, ID number, email address, and the like) and identification information for identifying external memory (external memory ID (USB memory ID)) as an identification information table described below. Note that the identification information table may store identification information such as a username, an ID number, and an email address of a user (which may include authentication information such as a login ID and a login password (PW)) and identification information of external memory (external memory ID (USB memory ID)) in association (linked) with each other, or may store identification information of external memory and a file identifier of a file included in the external memory in association with each other. Further, the identification information table may store a connection log of external memory to the image processing apparatus 100, a status related to job processing, and the like in association with the identification information.

The job data storage area 196 is a storage area that stores job data (for example, scanned data) generated by executing each job as a deliverable. Note that the job data storage area 196 may store not only deliverables but also intermediate products (for example, image data before OCR processing, various image processing, and encryption processing) generated in the course of execution of each job. The job data stored in the job data storage area 196, as long as savable as an intermediate product or a deliverable in accordance with the attachment/detachment timing of the external memory, is not limited to that data format or form.

The image former 21 includes a printer 211 and an image processor 213. The printer 211 feeds a sheet from a feeder 25, forms an image on the sheet based on image data, and then discharges the sheet to a discharger 27. The printer 211 may be constituted by, for example, a laser printer using an electrophotographic system. In this case, the printer 211 performs image formation using toners supplied from toner cartridges (not illustrated) corresponding to toner colors (for example, cyan, magenta, yellow, and black).

The image processor 213 generates image data by scanning a document image. The image inputter 213 can be configured as a scanner device that, in addition to an image sensor such as a charge coupled device (CCD) or a contact image sensor (CIS), for example, includes an automatic document feeder (ADF), a flatbed on which a document is set to be read, and the like. The image processor 213 is not particularly limited in configuration as long as capable of generating image data by reading a reflected light image from a document image using the image sensor. Note that the image processor 213 may be of a form that implements, for example, shading correction or density correction on image data input from the scanner device to generate image data for image transmission. Note that, in the disclosure, the image data generated by the image processor 213 (including image data subjected to various correction processing and encryption processing) is referred to as scanned data.

The I/O port 23 is a physical interface for connecting to external memory (USB memory). The I/O port 23 includes an attachment port corresponding to a shape of the external memory, and outputs, to the controller 11, a signal indicating that the external memory is connected when attachment of the external memory is detected. On the other hand, when detachment of the external memory is detected, a signal indicating that the external memory is detached is output to the controller 11.

Note that each of the functions described above may be duplicated when each function of the control device 101, the display device 103, the job processing device 105, and the image forming device 107 is individually realized. For example, each of the display device 103, the job processing device 105, and the image forming device 107 may include the controller 11 and the storage 19. Further, the devices may commonly utilize the controller 11, the storage 19, and the like.

### 1.2 Processing Flow

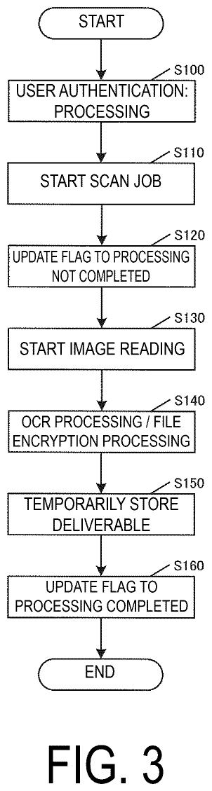

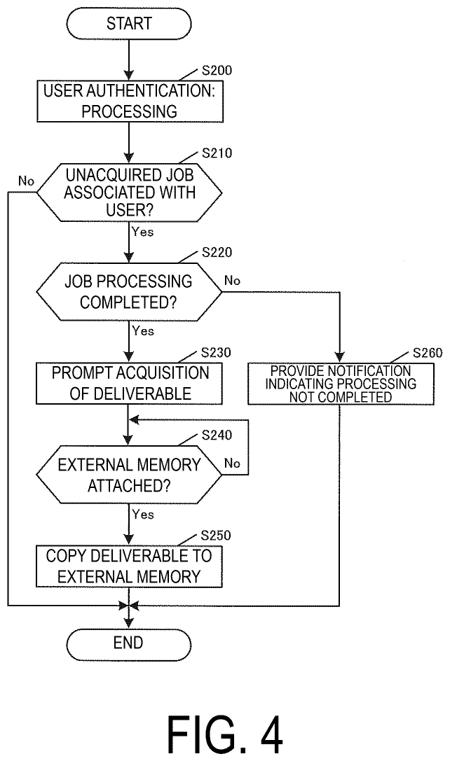

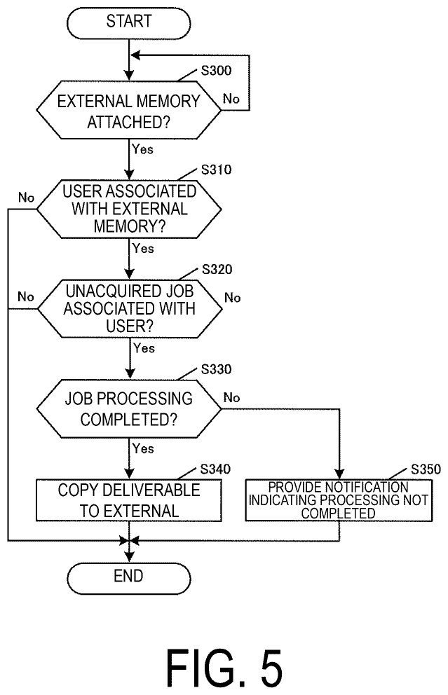

Next, a processing flow according to the first embodiment will be described. FIG. 3 is a flowchart for explaining processing related to saving scanned data in external memory. FIG. 4 and FIG. 5 explain the processing related to the acquisition of scanned data in the respective modes of with user authentication (FIG. 4) and without user authentication (FIG. 5). Note that the processing explained in FIG. 3, FIG. 4, and FIG. 5 is executed by the controller 11 reading the control program 191, the job control program 192, the I/O port control program 193, the user authentication program 194, and the like.

FIG. 3 illustrates an example in which a login operation on the image processing apparatus 100 is performed by a user and, once login authentication is successful, a scan job for a document image is executed.

First, the controller 11 performs user authentication processing in response to the login operation by the user (step S100).

Next, the controller 11 starts the scan job on the basis of an execution instruction of the scan job by the user successfully authenticated (hereinafter also referred to as login user; step S110).

At this time, the controller 11 updates a flag indicating the progress status of the scan job to “processing not completed” (step S120).

Then, the controller 11 starts reading the image (step S130). Next, the controller 11 performs, as necessary, OCR processing or file encryption processing on the image date generated by reading the image (step S140).

The controller 11 temporarily stores the scanned data of the deliverable obtained in step S130 or step S140 in the job data storage area 196 (step S150).

Then, the controller 11 updates the flag indicating the progress status of the scan job to “processing completed” and ends the processing (step S160).

Next, the processing in a case involving user authentication in the acquisition of scanned data will be explained with reference to the flowchart of FIG. 4.

First, the controller 11 performs user authentication processing in response to a login operation by the user (step S200). The controller 11 can determine, on the basis of the user authentication result, whether the user who provided the execution instruction of the scan job and the login user of the image processing apparatus 100 at the time of acquisition of the scanned data are the same. In the following description, an example will be described in which the user who provides the execution instruction of the scan job and the login user of the image processing apparatus 100 at the time of acquisition of the scanned data are the same.

Next, the controller 11 determines whether there is an unacquired job associated with the login user (step S210). When the determination is made that there is not an unacquired job associated with the login user, the controller 11 ends the processing (step S210: No→“End”).

On the other hand, when the determination is made that there is an unacquired job associated with the login user, the controller 11 determines whether the processing of the scan job related to the unacquired job is completed (step S210: Yes→step S220).

When the determination is made that the scan job related to the unacquired job is completed, the controller 11 prompts acquisition of the scanned data as a deliverable related to the scan job (step S220: Yes→step S230). Note that, in the first embodiment, a mode will be described in which a login user is prompted to acquire the unacquired scanned data by a notification via a notification screen described below.

Then, the controller 11 determines whether external memory was attached to the image processing apparatus 100 by the login user (step S240). When the determination is made that external memory is attached, the controller 11 copies the scanned data of the deliverable to the external memory and ends the processing (step S240: Yes→step S250→“End”). Note that, in the first embodiment, the external memory utilized when the scanned data is acquired may differ from the external memory utilized when the execution instruction of the scan job is provided. Even if the external memory utilized when acquiring the scanned data differs from the external memory utilized when providing the execution instruction of the scan job, the user authentication processing ensures that the operations are performed by the same user, maintaining security.

On the other hand, when the determination is made that external memory is not attached, the controller 11 waits until external memory is attached to the image processing apparatus 100 by the login user (step S240: No).

Note that, in step S220, when the determination is made that the scan job related to the unacquired job is not completed, the controller 11 provides notification that the processing is not completed as the processing of the scan job is not yet finished, and ends the series of processing (step S220: No→step S260→“End”).

When the user who provided the scan job execution instruction and the login user of the image processing apparatus 100 are not the same, the processing of step S220 and thereafter in FIG. 4 can be performed as long as the external memory utilized when the scanned data was acquired is the same as the external memory utilized when the scan job execution instruction was provided.

Next, the processing in a case not involving user authentication in the acquisition of scanned data will be described with reference to the flowchart of FIG. 5.

First, the controller 11 determines whether external memory was attached to the image processing apparatus 100 by the user (step S300). When the determination is made that external memory is not attached, the controller 11 waits until the external memory is attached (step S300: No).

On the other hand, when the determination is made that external memory is attached, the controller 11 determines whether there is a user associated with the external memory (step S300: Yes→step S310). When the determination is made that there is a user associated with the external memory, the controller 11 determines whether there is an unacquired job associated with the user (step S310: Yes→step S320).

When the determination is made that there is an unacquired job associated with the user, the controller 11 determines whether the processing of the scan job related to the unacquired job is completed (step S320: Yes→step S330).

When the determination is made that the scan job related to the unacquired job is completed, the controller 11 copies the scanned data as a deliverable related to the scan job to the external memory and ends the processing (step S330: Yes→step S340→“End”).

Note that, in step S330, when the determination is made that the scan job related to the unacquired job is not completed, the controller 11 provides notification that the processing is not completed as the processing of the scan job is not yet finished, and ends the series of processing (step S330: No→step S350→“End”).

When the determination is made in step S310 that a user associated with the external memory does not exist, or when the determination is made in step S320 that there is no unacquired job associated with the user, the controller 11 ends the processing (step S310: No or step S320: No→“End”).

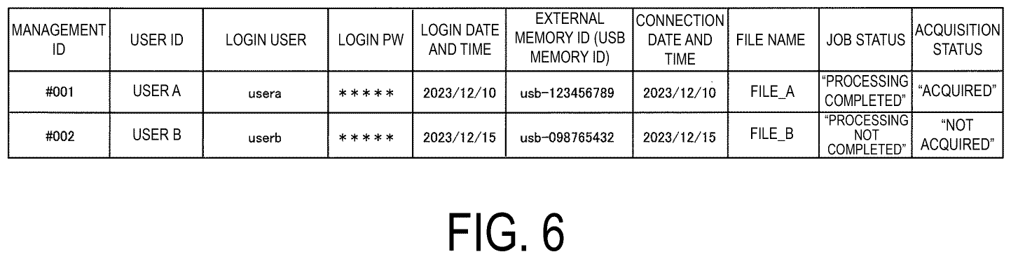

Here, a configuration example of an identification information table referenced by the controller 11 in step S210 and step S220 in FIG. 4, step S310 to step S330 in FIG. 5, and the like will be described with reference to FIG. 6. The identification information table illustrated in FIG. 6 can be configured as a table in which identification information of users (for example, usernames or the like) is associated with identification information of external memories, and can include a connection log of the external memories to the image processing apparatus 100 and a status related to job processing.

The identification information table illustrated in FIG. 6 is an example in which managed items managed in the table include a management ID, a user ID, a login user, a login password (login PW), a login date and time, an external memory ID (USB memory ID), a connection date and time, a file name, a job status, and an acquisition status. Note that, other than in a table format, the identification information table may be configured in a database format.

The management ID is an identifier for uniquely identifying information to be managed in the identification information table. The user ID is an identifier for identifying a user who utilizes the image processing apparatus 100, and is user identification information such as a username, an ID number, or an email address. The login user and the login password (login PW) are authentication information for the user identified by the user ID to log in to the image processing apparatus 100.

The login date and time indicates date and time information when the user identified by the user ID logged in to the image processing apparatus 100. The external memory ID (USB memory ID) indicates identification information of external memory utilized by the user identified by the user ID and is identification information of external memory associated with the user identified by the user ID. The connection date and time indicates date and time information when the external memory was connected to the image processing apparatus 100. The file name indicates the name of a file (job data such as scanned data) saved as a deliverable in the external memory or the name of a file to be subjected to job processing such as a print job described below.

The job status indicates the processing status of an executed job. The job status stores a flag value updated in accordance with the progress status of the job in step S120 and step S160 in FIG. 3. The acquisition status indicates an acquisition state of a deliverable generated by job processing.

For example, information identified by the management ID “#001” is identification information related to a user identified by the user ID “userA,” and is exemplified by the login user “usera,” the login password (login PW) “*****,” the login date and time “2023/12/1010,” the external memory ID (USB memory ID) “usb-123456789,” the connection date and time “2023/12/10,” the file name “file_A,” the job status “processing completed,” and the acquisition status “acquired.”

On the other hand, management information identified by the management ID “#002” is identification information related to a user identified by the user ID “userB,” and is exemplified by the login user “userb,” the login password (login PW) “*****,” the login date and time “2023/12/15,” the external memory ID (USB memory ID) “usb-098765432,” the connection date and time “2023/12/15,” the file name “file_B,” the job status “processing not completed,” and the acquisition status “not acquired.”

### 1.3 Operation Examples

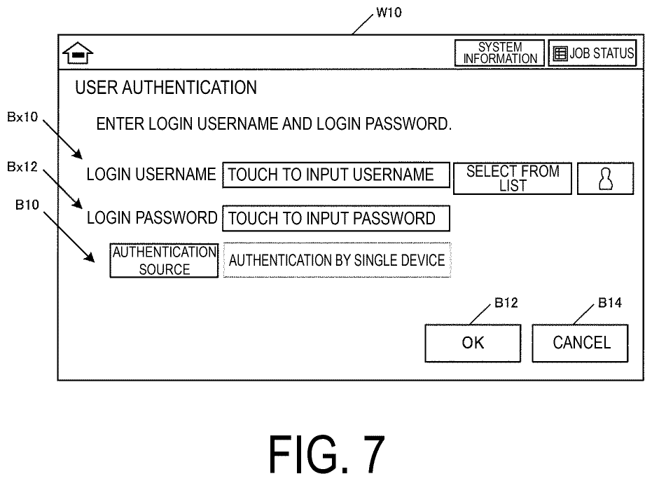

Next, operation examples according to the first embodiment will be described. FIG. 7 is a diagram illustrating a configuration example of a user authentication screen W10 for accepting a login operation by a user. Note that FIG. 7 is an operation example corresponding to the processing related to step S100 in FIG. 3, step S200 in FIG. 4, and the like.

The user authentication screen W10 can be configured as a login screen displayed on the display 13 (operation inputter 15) by the controller 11 after the controller 11 reads the user authentication program 194 in a case in which the user authentication function is enabled.

The user authentication screen W10 includes a login username input box Bx10, a login password input box Bx12, an authentication source designation button B10, an OK button B12, and a cancel button B14.

The login username input box Bx10 is an input box that receives input of a login username of the user attempting to log in to the image processing apparatus 100. The login username may be directly input by using an input device such as a keyboard, or may be input by selecting a username from a list of usernames (not illustrated), which is displayed by selecting a button of “Select from list” provided separately.

The login password input box Bx12 is an input box for receiving input of a login password corresponding to the login username. The controller 11 performs user authentication processing by comparing the login username input to the login username input box Bx10 and the login password input to the login password input box Bx12 with the identification information table illustrated in FIG. 6. When the respective input values of the login username input to the login username input box Bx10 and the login password input to the login password input box Bx12 match the respective authentication information of the login user and the login password (login PW) managed in the identification information table, the controller 11 can determine that the user authentication is successful.

The authentication source designation button B10 is a button for receiving designation of an authentication source for authenticating the user. The user authentication source may be the single image processing apparatus 100 or may be designated as, for example, an authentication server or the like (not illustrated) separately provided on the network NW. In this case, the authentication server can hold the authentication information of each of the login user and the login password (login PW) exemplified in FIG. 6, and perform the user authentication processing by transmitting the comparison result of the input values of the login username and the login password transmitted from the image processing apparatus 100 to the image processing apparatus 100.

The OK button B12 is a button for receiving an instruction to apply the input operation by the user. The user selects the OK button B12 to apply the input to the login username input box Bx10 and the login password input box Bx12 and apply the designation of the authentication source via the authentication source designation button B10. The cancel button B14 is a button for receiving an instruction to cancel input to the login username input box Bx10 and to the login password input box Bx12 and cancel the designation of the user authentication source via the authentication source designation button B10.

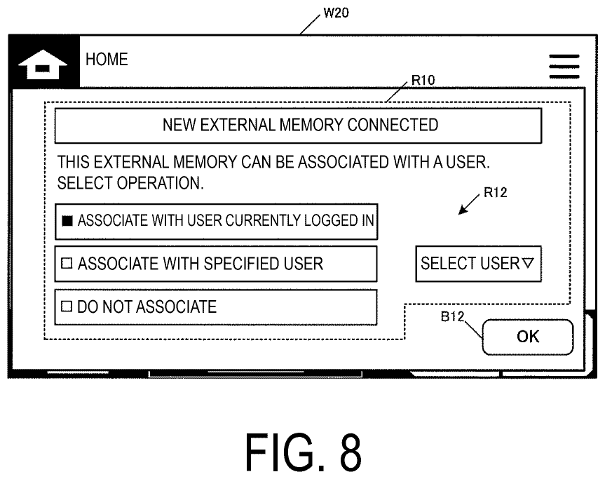

FIG. 8 is a diagram illustrating a configuration example of a setting screen W20 for receiving settings for associating identification information of users with identification information of external memories. Note that, although the identification information of the users and the identification information of the external memories can be associated with each other at desired timing, preferably the setting screen W20 exemplified in FIG. 8 is displayed to the login user and the settings entered by the login user are received at the timing of attachment of the external memory to the image processing apparatus 100 in consideration of user convenience.

The setting screen W20 includes a setting region R10 for receiving settings related to association of the external memory, and the OK button B12. The setting region R10 may include a region R12 including a checkbox for receiving selection of an association link of external memory and an enable/disable setting of the association, a pull-down menu for receiving selection of an association link selected by a user, and the like. FIG. 8 illustrates an example in which the region R12 is provided with a checkbox for accepting selection of either “Associate with user currently logged in” or “Associate with specified user” as an association link of the external memory, a pull-down menu for accepting selection of a user of the association link when the “Associate with specified user” checkbox is selected, and a “Do not associate” checkbox.

The OK button B12 is a button for receiving an instruction to apply the input operation by the user. When the selection instruction of the OK button B12 by the user is received, the controller 11 creates or updates the identification information table exemplified in FIG. 6 on the basis of setting content received through the setting screen W20.

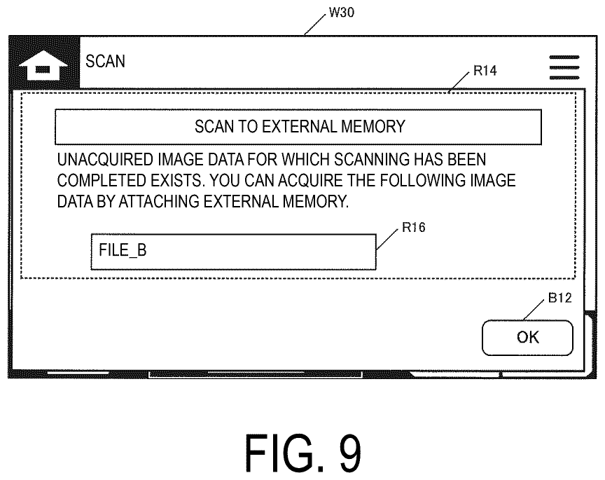

FIG. 9 is an example of a display configuration of a notification screen W30 for prompting the user to acquire scanned data as a deliverable related to a scan job when the controller 11 determines that the scan job related to an unacquired job is completed. Note that FIG. 9 is an operation example corresponding to the processing related to step S230 in FIG. 4.

The notification screen W30 includes a notification display region R14 and the OK button B12. The notification display region R14 is a display region that displays a notification of notification content prompting the user to acquire image data (scanned data). FIG. 9 illustrates the notification content, “Unacquired image data for which scanning has been completed exists. You can acquire the following image data by attaching external memory,” as an example. The notification display region R14 may be provided with a file name display region R16 indicating a file name of the image data. The login user confirms the file name displayed in the file name display region R16, facilitating identification of the image data (scanned date) to be acquired.

The OK button B12 is a button for receiving input of a confirmation instruction by the login user confirming the notification content of the notification screen W30. When a selection instruction of the OK button B12 selected by the login user is received, the controller 11 ends the display of the notification screen W30 and transitions the display screen to, for example, an operation screen related to the scan job.

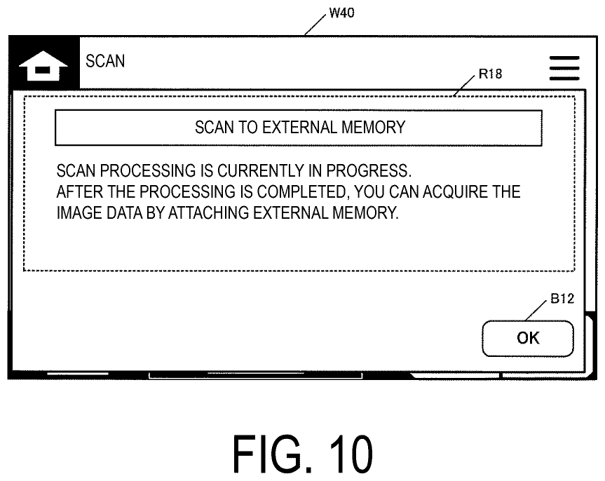

FIG. 10 is an example of a display configuration of a notification screen W40 that provides notification that processing is not completed as the processing of the scan job is not yet finished when the controller 11 determines that the scan job related to the unacquired job is not completed. Note that FIG. 10 is an operation example corresponding to the processing according to step S260 of FIG. 4 and step S350 of FIG. 5.

The notification screen W40 includes a notification display region R18 and the OK button B12. The notification display region R18 is a notification region for providing notification that the processing of the scan job is not completed. FIG. 10 illustrates the notification content, “Scan processing is currently in progress. After the processing is completed, you can acquire the image data by attaching external memory,” as an example.

The OK button B12 is a button for receiving input of a confirmation instruction by the login user confirming the notification content of the notification screen W40. When a selection instruction of the OK button B12 selected by the login user is received, the controller 11 ends the display of the notification screen W40 and transitions the display screen to, for example, an operation screen related to the scan job.

In the first embodiment, for job processing utilizing external memory, the user identification information and the identification information of the external memory are associated with each other in advance, eliminating the need to attach the external memory at the time of job execution and making it possible to reduce the number of times the external memory is attached to the image processing apparatus. Further, according to the first embodiment, the progress status of the job processing can be identified at the time of acquisition of the deliverable resulting from execution of the job, making it possible to easily identify the timing of acquisition of the deliverable and prevent failure to acquire the deliverable due to forgetfulness. Furthermore, in the first embodiment, output of a deliverable to external memory can be controlled on the basis of the user authentication function, making it possible to save the deliverable in the external memory even if the external memory utilized when the deliverable is acquired differs from the external memory utilized when the job execution instruction was performed.

### 2. Second Embodiment

In a second embodiment, a form of printing a file saved in external memory (print job) will be described.

A functional configuration of a multifunction peripheral as the image processing apparatus according to the second embodiment can be substantially the same as the functional configuration of the image processing apparatus 100 according to the first embodiment. Accordingly, a description of the functional configuration of the image processing apparatus according to the second embodiment will be omitted.

### 2.1 Processing Flow

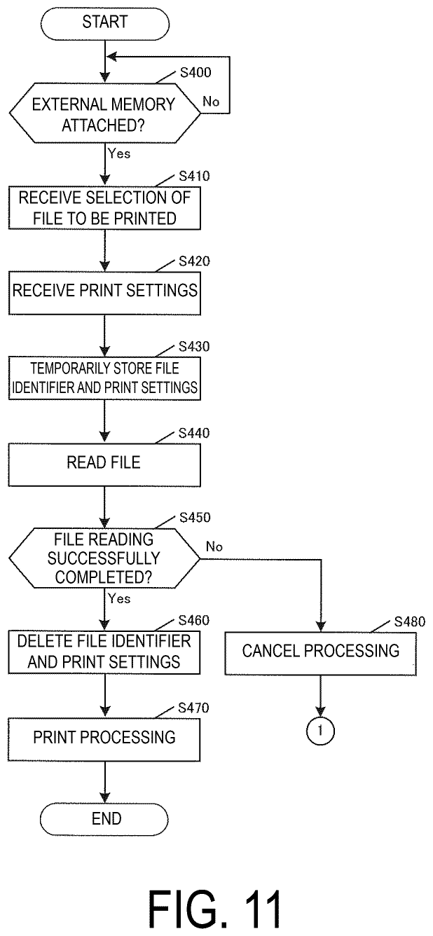

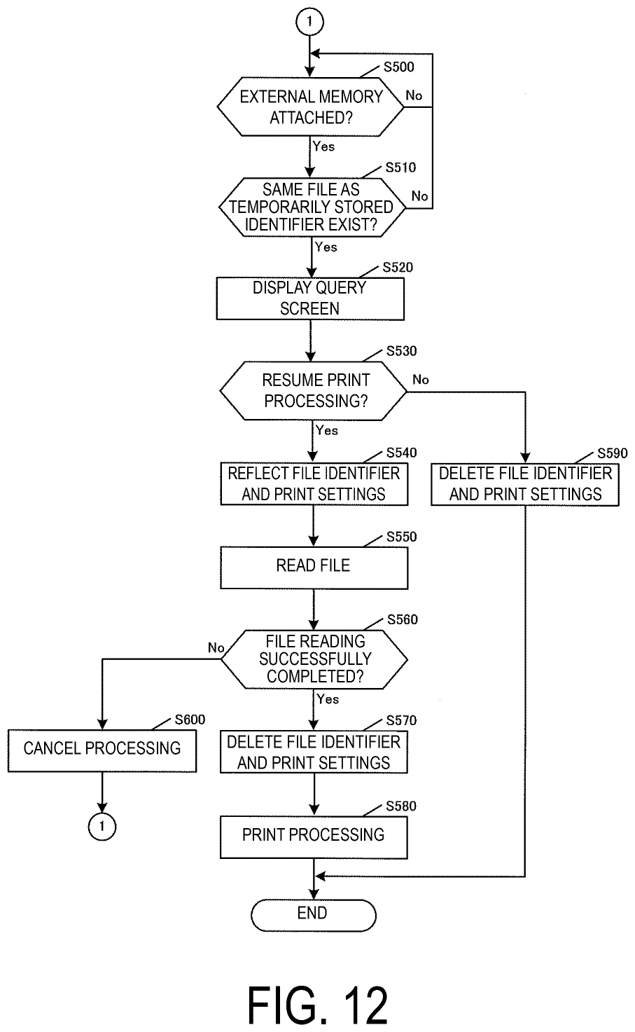

A processing flow according to the second embodiment will now be described. FIG. 11 and FIG. 12 are flowcharts illustrating processing for printing a file saved in external memory. Note that the processing described with reference to FIG. 11 and FIG. 12 is executed by the controller 11 reading the control program 191, the job control program 192, the I/O port control program 193, and the like.

First, the controller 11 determines whether external memory was attached to the image processing apparatus 100 by the user (step S400). When the determination is made that external memory is not attached, the controller 11 waits until external memory is attached to the image processing apparatus 100 by the user (step S400: No).

On the other hand, when the determination is made that external memory is attached, the controller 11 receives selection of a file to be printed that is saved in the external memory (step S410).

Next, the controller 11 receives print settings for printing the selected file to be printed (step S420). The controller 11 temporarily stores the identifier for identifying the file to be printed and the print settings received in step S420 (step S430).

The controller 11 reads the file to be printed from the external memory (step S440). Then, the controller 11 determines whether the reading of the file was successfully completed (step S450).

When the determination is made that the reading of the file was successfully completed, the controller 11 deletes the identifier of the file and the print settings stored in step S430 (step S450: Yes→step S460). Then, the controller 11 performs print processing on the file and ends the processing (step S470→“End”).

On the other hand, when the determination is made that the reading of the file is not successfully completed because the external memory was detached from the image processing apparatus 100 during file reading, for example, the controller 11 cancels the processing (step S450: No→step S480).

After cancellation of the processing, the controller 11 determines whether external memory was attached to the image processing apparatus 100 by the user (step S500). When the determination is made that external memory is not attached, the controller 11 waits until external memory is attached to the image processing apparatus by the user (step S500: No).

On the other hand, when the controller 11 determines that external memory is attached, the controller 11 determines whether a file having the same identifier as the identifier of the file temporarily stored in step S430 of FIG. 11 exists in the external memory (step S500: Yes→step S510). When the determination is made that a file having the same identifier as the identifier of the temporarily stored file does not exist in the external memory, the controller 11 returns the processing to step S500 (step S510: No→step S500).

When the determination is made that a file having the same identifier as the identifier of the temporarily stored file exists in the external memory, the controller 11 displays a query screen for inquiring whether to resume the printing of the file with the print settings received in step S420 (step S510: Yes→step S520).

When an instruction to resume printing is received from the user via the query screen, the controller 11 reflects the identifier of the file and the print settings and then reads the file (step S530: Yes→step S540→step S550).

Then, the controller 11 determines whether the reading of the file is successfully completed (step S560). When the determination is made that the reading of the file is successfully completed, the controller 11 deletes the identifier of the file and the print settings (step S560: Yes→step S570). Next, the controller 11 performs print processing on the file and ends the processing (step S580).

On the other hand, when the determination is made that the reading of the file has not been successfully completed, the controller 11 cancels the processing and returns the processing to step S500 (step S560: No→step S600→step S500).

When an instruction to resume the printing from the user is not received via the query screen, the controller 11 deletes the identifier of the file and the print settings and ends the processing (step S530: No→step S590→“End”).

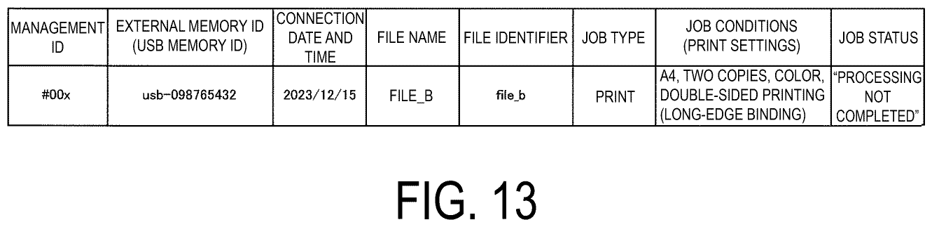

Here, a configuration of the file identification information table referenced by the controller 11 in step S510 and the like of FIG. 12 will be described with reference to FIG. 13. The file identification information table illustrated in FIG. 13 can be configured as a table in which the identifier of the file to be printed and the print settings for printing the file are associated with each other on the basis of the processing related to step S410 to step S430 of FIG. 11.

The file identification information table exemplified in FIG. 13 is an example in which a management ID, an external memory ID (USB memory ID), a connection date and time, a file name, a file identifier, a job type, print settings (job conditions), and a job status are managed items managed in the table. Note that, other than in a table format, the file identification information table may be configured in a database format.

The management ID is an identifier for uniquely identifying information managed in the file identification information table. The external memory ID (USB memory ID) indicates identification information of the external memory utilized by the user. The connection date and time indicate date and time information when the external memory was connected to the image processing apparatus 100.

The file name indicates a name of a file (print data) saved in the external memory identified by the external memory ID and subjected to job processing such as a print job. The file identifier is an identifier for uniquely identifying the file indicated by the file name.

The job type indicates a job type such as a print job executed for the file identified by the file name or the file identifier. The job conditions (print settings) indicate job conditions for executing the job identified by the job type. The job status indicates the processing status of an executed job. The job status stores a flag value updated in accordance with the progress status of the job in step S450 in FIG. 11 and step S560 in FIG. 12.

For example, the information identified by the management ID “#00x” is file identification information related to external memory identified by the external memory ID (US memory ID) “usb-098765432,” and indicates the connection date and time “2023/12/15,” the file name “file_B,” the file identifier “file_b,” the job type “print,” the job conditions (print settings) “A4 (print sheet), 2 copies (number of copies), color (monochrome/color setting), double-sided printing (long-edge binding) (double-sided/single-sided setting (binding direction)),” and the job status “processing not completed.”

### 2.2 Operation Example

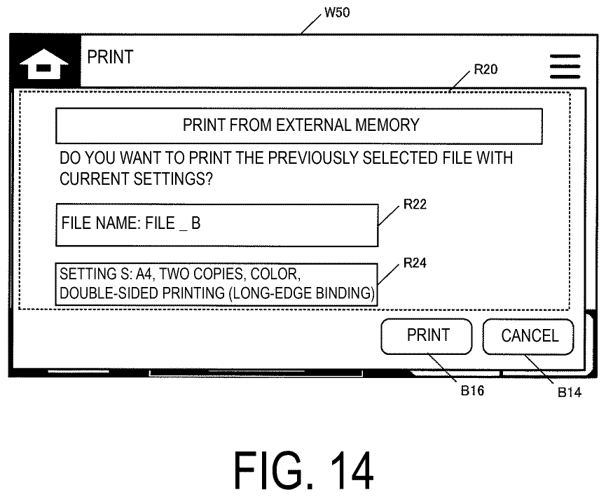

Next, an operation example according to the second embodiment will be described. FIG. 14 illustrates an example of a display configuration of a query screen W50 for inquiring whether to resume printing when the determination is made that a file having the same identifier as the identifier of the temporarily stored file exists in the external memory. Note that FIG. 14 is an operation example corresponding to the processing related to step S520 in FIG. 12.

The query screen W50 includes a query display region R20, a print button B16, and the cancel button B14. The query display region R20 is a display region that displays content inquiring whether the user wants to resume printing with the set print settings. FIG. 14 illustrates “Do you want to print the previously selected file with current settings?” as the query contents. The query display region R20 can be provided with a file name display region R22 that displays a file name for which printing is to be resumed and a job condition display region R24 that displays job conditions (print settings) applied to a file identified by the file name. The user can identify the file for which printing is to be resumed and the job conditions (print settings) by confirming the display contents displayed in the file name display region R22 (for example, file_B) and the job condition display region R24 (for example, A4, 2 copies, color, and double-sided printing (long-edge binding)).

The print button B16 is a button for receiving an instruction to execute the print job from the user. The user can execute the print job for the file by selecting the print button B16 after confirming the display contents displayed in the file name display region R22 and the job condition display region R24. The cancel button B14 is a button for receiving an instruction to cancel execution of the print job based on the display contents displayed in the file name display region R22 and the job condition display region R24.

As described above, according to the second embodiment, even in the event that the reading of a file saved in the external memory fails, the print job for the file can be quickly resumed by attaching the same external memory to the image processing apparatus.

### 3. Third Embodiment

The third embodiment is an embodiment of an image processing apparatus including, in addition to the configuration of the first embodiment, a notification provider that, when scanned data of a deliverable is not acquired within a predetermined period, provides a notification by, for example, audio, light, or email, the notification prompting acquisition of the deliverable.

### 3.1 Functional Configuration

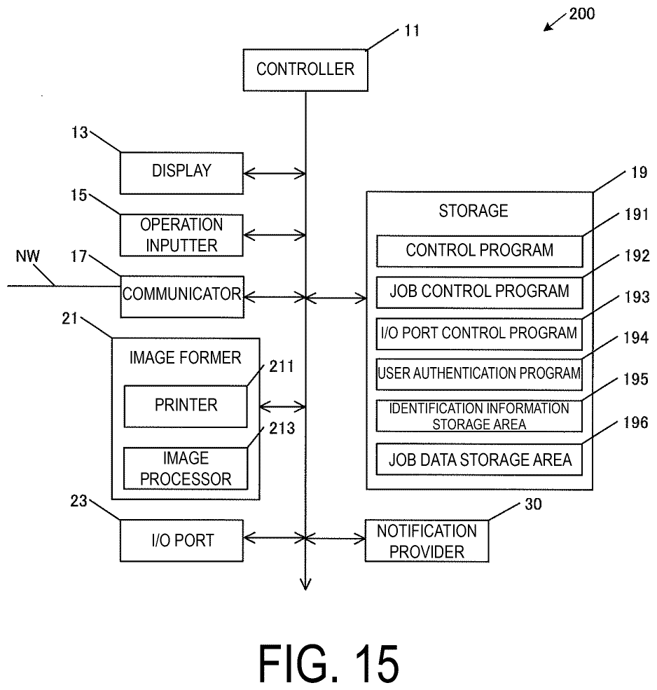

FIG. 15 is a diagram for explaining a functional configuration of an image processing apparatus 200. The image processing apparatus 200 includes a notification provider 30 in addition to the configuration of the image processing apparatus 100 according to the first embodiment.

The notification provider 30 includes a timer (not illustrated), an audio output device that generates and outputs an audio signal (for example, beep sound or combination thereof, or audio reading of notification content) corresponding to the notification content (text information) provided to the user, a light-emitting device that expresses the notification content to the user by controlling an emission pattern or an emission color of light, or the like. When the deliverable is not acquired within a predetermined period after scan job completion and deliverable generation, the notification provider 30 provides notification prompting acquisition of scanned data as the deliverable together with or separately from display of the notification content on the display 13 (operation inputter 15). Note that, in addition to the audio output device and the light-emitting device, the notification provider 30 may be configured to provide notification by a notifier such as email or short message service (SMS) as a way of notification.

A processing flow and an operation example according to the third embodiment can be similar to those according to the first embodiment, and thus description thereof will be omitted here.

As described above, according to the third embodiment, in addition to the effects of the first embodiment, even in a situation in which the (login) user cannot confirm the notification content on the display (operation inputter) or when the user forgets to acquire the deliverable, it is possible to provide the user with a notification prompting acquisition of the scanned data.

The disclosure is not limited to the embodiments described above and various modifications can be made. In other words, embodiments obtained by combining technical mechanisms appropriately changed without departing from the gist of the disclosure are also included in the technical scope of the disclosure.

Although some parts of the above-described embodiments are described separately for convenience of explanation, it is a matter of course that combinations can be executed within a technically allowable range.

The programs running on each device in the embodiments are programs for controlling a CPU or the like (programs for causing a computer to function) to implement the aforementioned functions in the embodiments. The information handled by these devices is temporarily accumulated in a transitory storage device (for example, a RAM) at the time of processing, is then stored in a storage device such as various read only memories (ROMs) or HDDs, and is read, modified, and written by the CPU as needed.

As a non-transitory computer readable recording medium storing therein a program in the information processing device, any of a semiconductor medium (for example, a ROM or a nonvolatile memory card), an optical recording medium or a magneto-optical recording medium (for example, a digital versatile disc (DVD), a magneto optical disc (MO), a mini disc (MD), a compact disc (CD), or a Blu-ray (trade name) disc (BD)), a magnetic recording medium (for example, a magnetic tape or a flexible disk), and the like may be used. In this case, since the program recorded in the recording medium is read by a computer of the information processing device and executed by the computer, not only the aforementioned functions of the embodiments are implemented, but also the functions of the disclosure are implemented by performing processes in cooperation with an operating system, another application program, or the like based on the commands of the program.

In a case in which the programs are distributed to the market, the programs can be stored and distributed in a portable recording medium, or can be transferred to a server computer connected via a network such as the Internet. In this case, it is a matter of course that the storage device of the server computer is also included in the disclosure.

In addition, each functional block or each characteristic of the device used in the above-described embodiments can be implemented and executed by an electric circuit, for example, an integrated circuit or a plurality of the integrated circuits. An electric circuit designed to implement the function described herein may include a general-purpose processor, a digital signal processor (DSP), an application specific integrated circuit (ASIC), a field programmable gate array (FPGA) or other programmable logic devices, discrete gate or transistor logic, discrete hardware components, or a combination thereof. The general-purpose processor may be a microprocessor, or any known processor, controller, microcontroller, or state machine. The above-described electric circuit may be constituted by a digital circuit or an analog circuit. In addition, in a case in which an integrated circuit technology that replaces the current integrated circuit becomes available due to advancement of the semiconductor technology, one or more aspects of the disclosure can use a new integrated circuit based on the new integrated circuit technology.

### REFERENCE SIGNS LIST

11 Controller
13 Display
15 Operation inputter
17 Communicator
19 Storage
191 Control program
192 Job control program
193 I/O port control program
194 User authentication program
195 Identification information storage area
196 Job data storage area
21 Image former
211 Printer
213 Image processor
23 I/O port
30 Notification provider
100, 200 Image processing apparatus
101 Control device
103 Processing device
105 Job processing device
107 Image forming device

1. A job processing device comprising:
an authenticator that authenticates login of a user;
an executor that executes a job on the basis of an execution instruction from the user authenticated; and
one or more controllers that control output of a deliverable resulting from execution of the job to a portable storage medium,
wherein the one or more controllers, when the deliverable is acquired via the portable storage medium and a logged-in user is the same as the user providing the execution instruction of the job, notify the user of a processing status of the job in the executor.

2. The job processing device according to claim 1,
wherein the one or more controllers provide a notification prompting acquisition of the deliverable when processing of the job is completed, and provide a notification that the processing of the job is not completed when the processing of the job is not completed.

3. The job processing device according to claim 1,
wherein the one or more controllers, when the portable storage medium attached differs between when the job is executed and when the deliverable is acquired, output the deliverable to the portable storage medium.

4. The job processing device according to claim 1,
wherein the one or more controllers
store identification information of the portable storage medium and identification information of the user in association with each other, and
output the deliverable to the portable storage medium when the portable storage medium associated with the user providing the execution instruction of the job is attached.

5. The job processing device according to claim 1,
wherein the one or more controllers
store an identifier of a file stored in the portable storage medium, and
when execution of the job for the file is canceled and subsequently the portable storage medium, detached, is re-attached, provide the user with a notification inquiring whether to resume execution of the job on the basis of the identifier of the file.

6. An image processing apparatus comprising:
an authenticator that authenticates login of a user;
an image processor that executes a job related to image processing on the basis of an execution instruction from the user authenticated; and
one or more controllers that control output of a deliverable resulting from execution of the job to a portable storage medium,
wherein, the one or more controllers, when the deliverable is acquired via the portable storage medium and a logged-in user is the same as the user providing the execution instruction of the job, notify the user of a processing status of the job in the executor.

7. A job processing method comprising:
authenticating login of a user;
executing a job on the basis of an execution instruction from the user authenticated; and
controlling output of a deliverable resulting from execution of the job to a portable storage medium,
wherein, when the deliverable is acquired via the portable storage medium and a logged-in user is the same as the user providing the execution instruction of the job, the user is notified of a processing status of the job.
